(19) United States
(12) Patent Application Publication
(10) Pub. No.: US 2009/0073498 A1
(43) Pub. Date: Mar. 19, 2009

(54) Printing method for open page surface of book

(76) Inventor: Karl Markwardt, Utica, NY (US)

Correspondence Address: David Giglio, Esq., 231 Elizabeth Street, Utica, NY, 13501, US

(21) Appl. No.: 11/900,599

(22) Filed: Sep. 13, 2007

(51) Int. Cl. H04N 1/387

(52) U.S. Cl. 358/296

(57) ABSTRACT

The present invention provides a method and apparatus for printing an image to an open end surface of bound document during the printing process. The method and apparatus slices an open edge image to the outer edges of the obverse surface of a select number of pages. The image is crept incrementally increasingly inward through a registered window with each consecutive page sheet. The amount of each increment is equivalent to the height of the open edge image divided by the number of page sheets the image will occupy on the open surface of the bound document.

### FIELD OF THE INVENTION

The present invention relates generally to the field of printing books and, more particularly, to a method and apparatus to print an image to an open edge surface of a bound document.

### BACKGROUND OF THE PRESENT INVENTION

It is well known in the field of printing that various methods and apparatus can be used to produce books, magazines, and other bound documents. The bound documents typically comprise a number of individual sheets. The sheets may be of a single type of paper or may have various paper types. The thickness of each sheet of paper depends upon the paper type.

The three most common forms of printing today include offset sheet fed which feeds a large sheet of paper through a printing press; offset web with feeds a large roll of paper through a printing press; and xerography in which an electrostatic charged drum contains an image in which toner sticks to the drum image and is then transferred to the paper. Each of these forms of printing is well known in the art.

In most bound document type printing processes, such as for telephone books, the images to be printed on each page are stored in memory in various formats including Text, Tiff, PDF, JPEG or other known image formats.

It is known in the art to combine different type of formats to a single document page. This type of printing is known as object linking and embedding (“OLE” sometimes also known as dynamic data exchange or “DDE”). The technology underlying OLE is sophisticated, but is well understood in the art. Reference may be made to many patents including U.S. Pat. No. 5,581,760 which is incorporated by reference herein and reference books (eg. Brockschmidt, Inside OLE 2, Microsoft Press, Redmond, Wash., 1994).

It is also known in the art to identify and provide a watermark imagery to select documents pages which is described in U.S. Pat. No. 7,209,573 which is also incorporated herein by reference.

Thus a bound document contains multiple pages, each of which may contain images from the same or different formats.

One problem with these bound documents is that as individuals build libraries of bound documents or books, it is often difficult to distinguish which book or document is on the shelf, especially where books are stacked upon each other. Often times, the bound side contains some reference identifier indicating the name of the book. However, in many cases, these titles are difficult to read or sometimes the description of the title does not necessarily indicate the true description of the nature of the book.

In the workplace in many fields, field workers and others will develop a series of technical manuals. The covers are often times bound with index type paper bound with two staples in the left hand margin for which it is often difficult to handwrite the name of the book on the bound side. Thus, the user must select many manuals, remove them from the shelves and then look to the front cover to determine the name of the book.

In certain college curriculum, many of the covers of different books appear similar with difficult to read writing on the cover or may require book covers. The student must often sift through a number of these books in order to identify the present day's necessary books.

To make things easier, students oftentimes write the name of the subject across the open ends of the white sheets in black ink the name of the subject for which the book covers. This allows the student a quicker opportunity to select the day's books. However, writing on the books defaces the document itself, thus making is less valuable for resale.

For telephone books, it is desirable to sell advertising space. Typically advertising space on the covers is the most preferred because of its visibility. As anybody can plainly see from lifting and viewing a telephone book advertising space is wasted on the open ends of the sheets.

There presently exists special printers which print directly to the open surfaces of a book. However, these special printers require an extra step, more equipment and therefore slow down the printing process.

### SUMMARY AND OBJECTS OF THE PRESENT INVENTION

It is an object of the present invention to improve the art of printing.

It is another object of the present invention to improve the field of advertising.

It is a further object of the present invention to make use of unused advertising space for many bound documents.

It is a feature of the present invention to print an image to an open surface edge of a book.

These and other objects and features are provided in accordance with the present invention in which there is a method for printing at least one open edge image to a bound document having a plurality of page sheets, wherein each of said page sheets has at least one obverse surface and wherein each of said page sheets includes at least three open edges. The plurality of page sheets forms at least three open edge surfaces. The open edge image is printed to at least one of the open edge surfaces.

The method includes the step of entering open edge image data indicative of the open edge image into a memory. The open edge image data is positioned for height, width and location. A window is registered at the desired location. The open edge image is incrementally crept through the registered window on a limited number of successive page sheets.

The open edge image may be input to memory by a number of means including a scanner, a keyboard, a digital camera memory input and even downloading a file over the internet.

### BRIEF DESCRIPTION OF THE DRAWINGS

The present invention will be understood and appreciated more fully from the following detailed description taken in conjunction with the drawings in which:

FIG. 1 is a top view of an obverse, surface of a single page sheet showing a pair of windows;

FIG. 2 is a side view of a staple bound document;

FIG. 3 is a top view of the first page of an open edge image creeping through a window;

FIG. 4 is a top view of the last page of an open edge image creeping through a window;

FIG. 5 is a top view of the obverse surface of the first page depicted in FIG. 3;

FIG. 6 is an top elevation perspective view of a bound document in accordance with the present invention; and

FIG. 7 is a flowchart depicting a method of performing the present invention.

### DETAILED DESCRIPTION OF THE PRESENT INVENTION

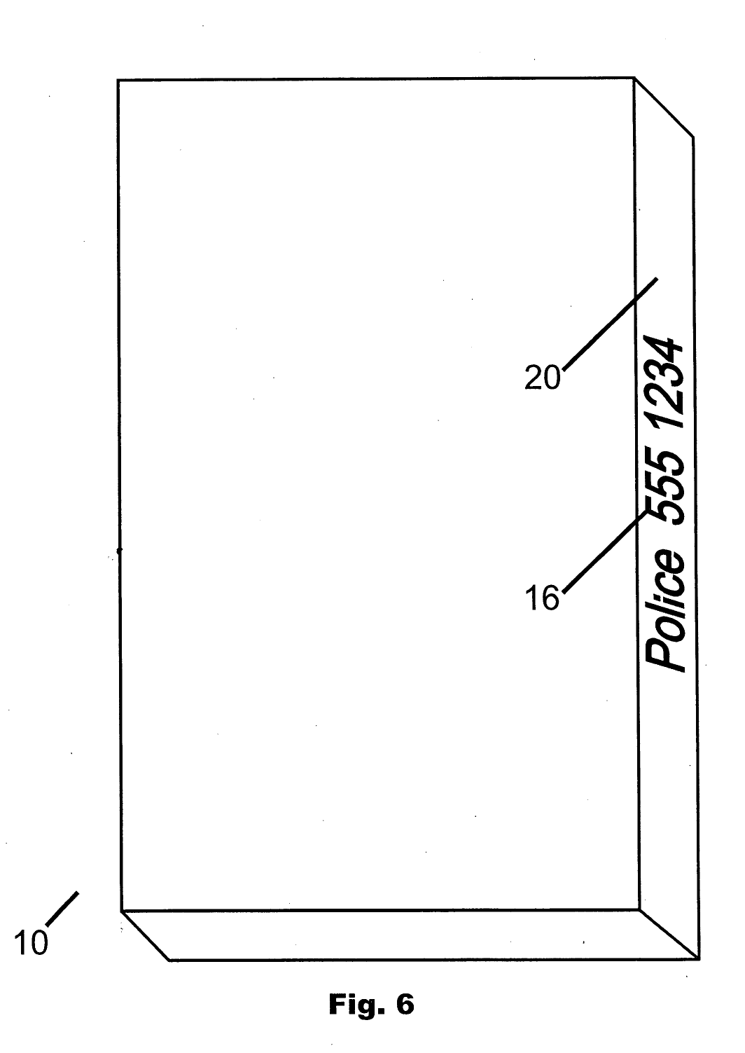

Looking at FIG. 6, the present invention provides a method for producing an open edge image 16 to the open sheet ends, also referred to herein as an open edge surface 20, of a bound document 10, such as a book without the necessity of a special open edge surface printer. As defined herein bound document 10 means any bound document having multiple individual sheets such as books, magazines, manuals and the like.

As mentioned earlier, and as is well known in the art, there are many graphics programs, such as Quark Express or Adobe Indesign, that are used to put print to bound documents. These programs have many built in features. Among these features, a few will be described and used in accordance with a preferred embodiment of the present invention. These features are included in imposition programs such as Kodak Preps or Xerox Freeflow.

The first of these features is the ability to manipulate separate print files and combine the separate print files to a single printed page even where the print files may be in separate print formats. The print file formats typically include Text, Tiff, PDF, JPEG or other known image formats. The manner in which these programs combine files and the different printing techniques are all well known in the art and need not be detailed herein.

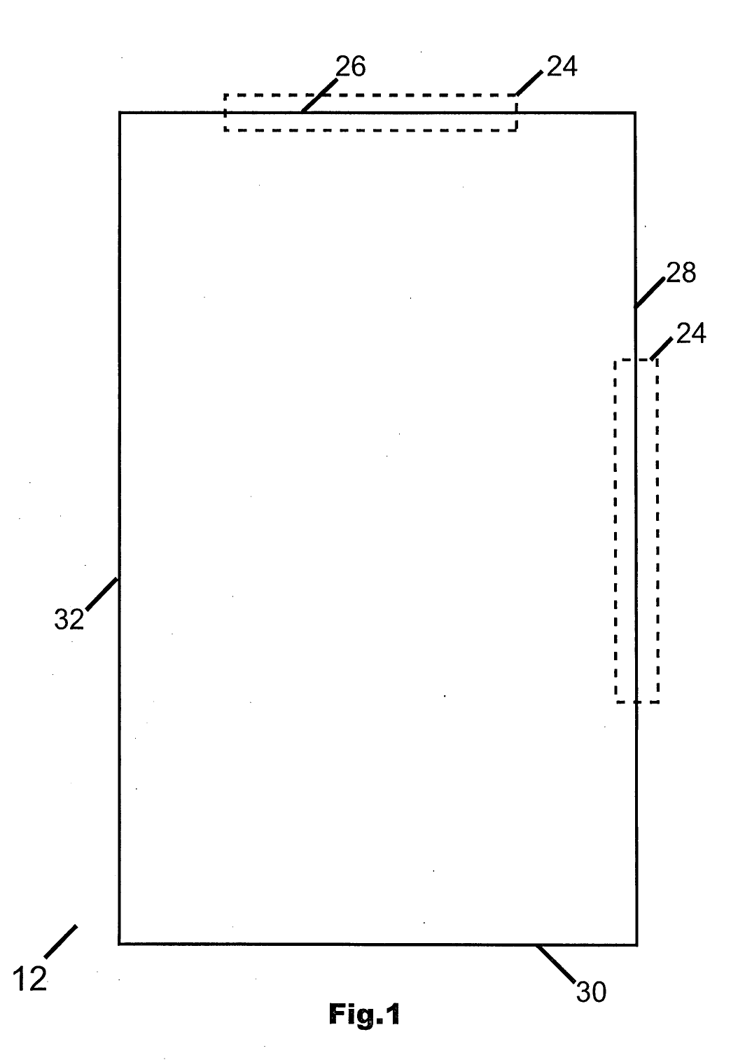

The next of the important graphics program features relevant to the present invention is the ability to window a portion of a single page sheet 12, depicted in FIG. 1. Windowing simply means that a pre-defined area of a single or multiple pages blocks a first print file and allows a second print file to be printed therein. A window 24 is shown in accordance with the present invention. The window 24 may be registered for every page sheet or multiple page sheets of the bound document.

For the purposes of the present invention, the window 24 is registered for size and location so that it encompasses both on and off of a page border 28. Master page item is typically used to register the window. Every printing equipment contains certain tolerances. For example, as sheets of paper are passed through a printing tray, some of the sheets slide a little to the left or right as they pass through. As such, print margins from page to page will have varying locations, albeit a small variance, based upon the tolerance of the ability of the printer to pull the papers evenly through the printer.

In another example, the same slipping effect occurs during the cutting process, wherein a large roll or sheet of paper is cut into individual sheets. Each sheet may vary in length and width according to the tolerance of the cutter.

Thus, the window 24 is registered to a border edge, such as a side border edge 28 or top border edge 26, which is depicted in FIG. 1, to accommodate both the printing and cutting tolerances and ensure that only a desired portion of the open edge image is printed to the window 24. Thus, the window 24 overlaps the border edges 26, 28 as depicted in FIG. 1.

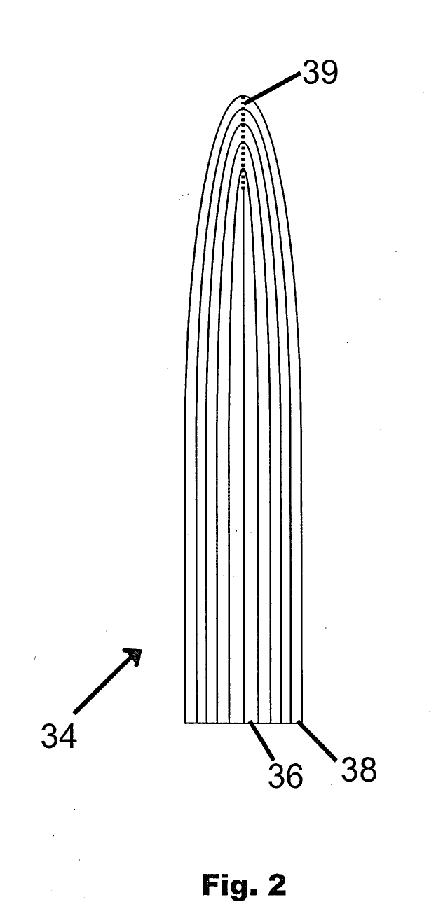

Another important feature in graphics programs is the ability to creep a print file or files from page to page. Creeping is typically utilized in staple bound documents such as magazines or even unbound documents such as newspapers. As one notices when looking at a staple bound document 34, which is depicted in FIG. 2, each of the sheets of paper in the document contain four printed pages. Due to the way that an inner sheet of paper 36 is folded into an outer sheet 38 and so on, the inner sheets of paper are actually shorter than the outer sheets. Therefore to make the print align from sheet to sheet, the print files are incrementally crept to accommodate the differing sheet dimensions. Staples 39 are used to bind the magazine. Creeping is well known in the art.

When looking at a magazine or other printed material, one notices that print to the outer most border of a page appears on the open edge of the page when looking from the side. To create an entire image to an open edge of a sequence of pages, one creeps the open edge image into the preset border window until the open edge image has been fully crept past the window and out of view.

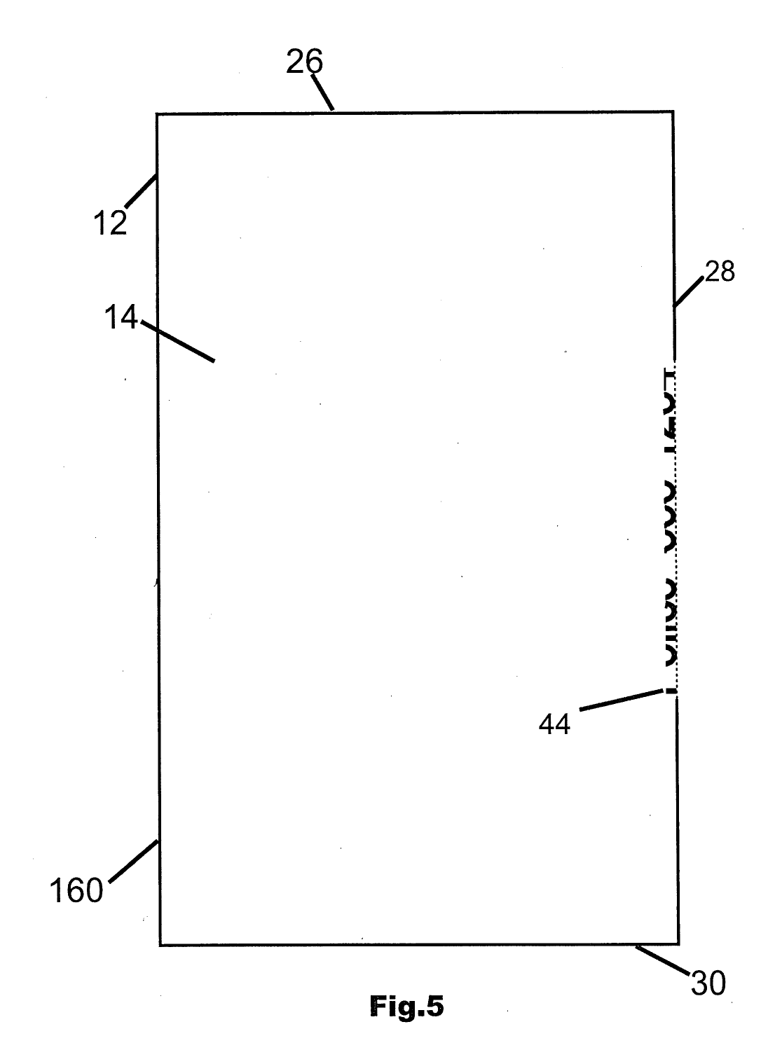

The open edge surface area 20, shown in FIG. 6, is formed from a plurality of sheet edges 28, which are depicted in FIG. 1, which are then stacked onto each other. It is also desirable that the open edge image 16 be practically unnoticeable or as unoffensive as printing and binding tolerances permit so that more of the obverse page surface 14 is used for other purposes or for aesthetic purposes. A reader viewing a single obverse page surface 14 of the bound document 10 may be distracted if too much of a portion 44 of the open edge image 16 were to appear on the obverse page surface 14, which is depicted in FIG. 5.

The types of open edge images typically include advertising, the name of the book, designs or other types of images.

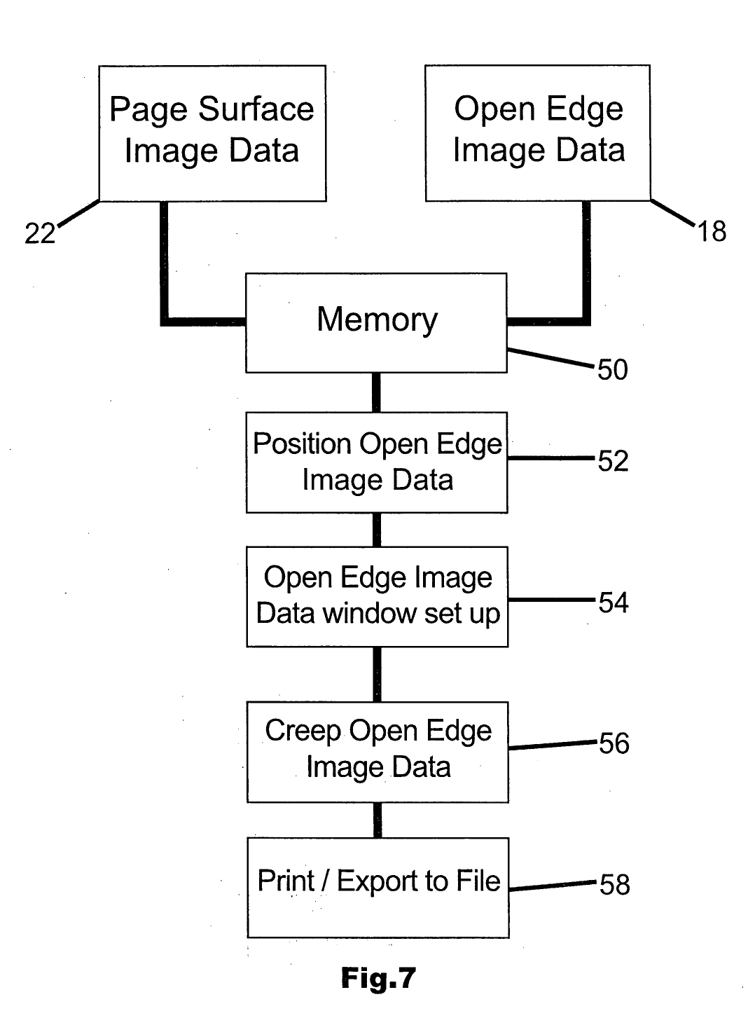

The method for using the present invention is shown in FIG. 7. The first step is to create page surface image data, depicted as step 22, and transmit the page surface image data into memory, depicted in step 50.

A user then creates and inputs the open edge image data also into memory shown in steps 18 and step 50. The open edge image data may be created using any digital source such as a keyboard, scanner, a remote memory such as a camera memory or downloaded via the internet. The memory may be either remote or internal to the printer.

The open edge image is typically created in graphic design formats such as .eps, .tiff, .pdf, .bmp, .jpeg etc.

In the graphic arts industry a dummy book is made of stock and simply measured to determine the height and width. This can be performed manually or virtually via a processor. The user may manually registers the open edge image data for height, length and beginning and ending page for printing. Alternatively, the processor may compute the same for the calculated dimensions of the dummy book. The user also determines onto which open edge surface or surfaces the open edge image will be printed. Each of these steps is referred to as registering the open edge image data, step 52, which is also depicted in FIG. 7.

The user then sets the window register, step 54, for location and tolerances. The window register is typically set for the entire document, but may alternatively be set for a limited number of pages. Where the document includes duplexed printing, the window is set only to the odd pages of the document.

As the printing process occurs, the open edge image is crept through the window from page sheet to page sheet so that a minute portion of the open edge image is printed to the page edge for each of a sequence of page sheets. The amount of creeping from page sheet to page sheet is determined by dividing the height of the open edge image by the number of page sheets that the open edge image will appear. Thus, the open edge image will be crept this divided increment on each incremented page. For example, if the open edge image were one inch in height and was to appear on one hundred page sheets, then the open edge image must be crept by 0.01″ per page. If the open edge image is one inch then the image will be crept by one/one hundredth of an inch per page sheet. Thus, the user next sets the creep, step 56.

The final step is to print the bound document or export to file for remote or later printing, step 58.

Turning now to an example of the present invention, lets suppose that it is desired to insert the term “Police 555 1234” as the open edge image 16. The user first makes a dummy book to measure for the open edge surface area 20, depicted in FIG. 6. The user inputs the term “Police 555 1234” into memory via a keyboard. As mentioned earlier, the open edge image 16 may be input through various means or even downloaded via the internet.

The user then registers the open edge image 16 for location, size and beginning and ending pages. The user next sets the window register for location and tolerances. The window may be set at various locations along the page edge. Finally, the user determines and sets the creep increment as described herein in step 56 of FIG. 7.

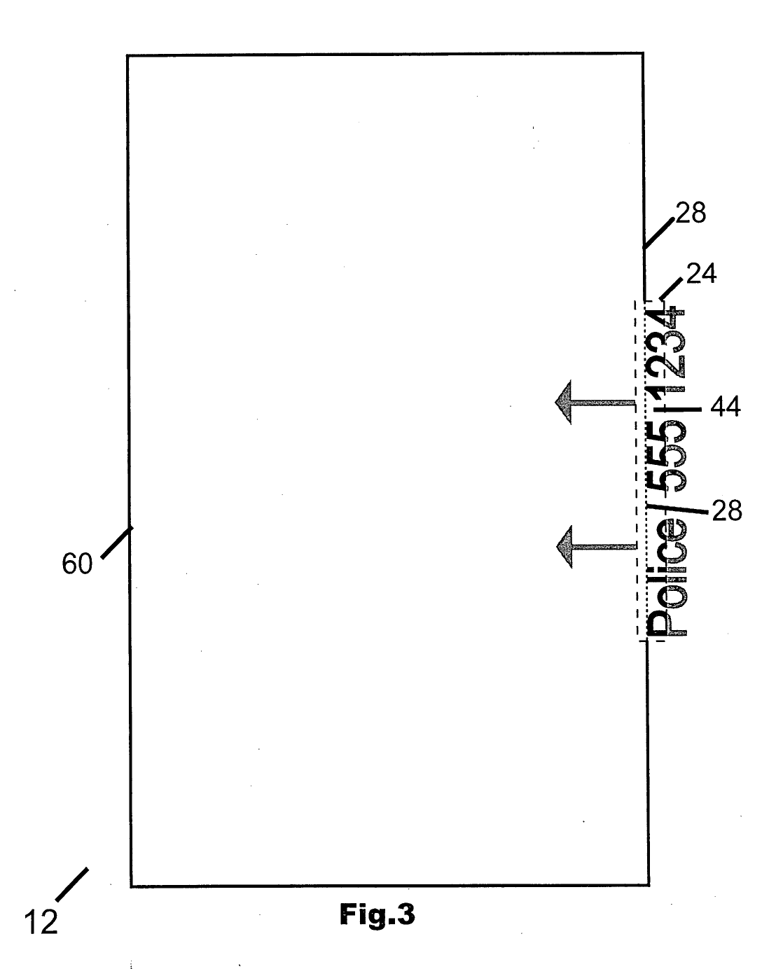

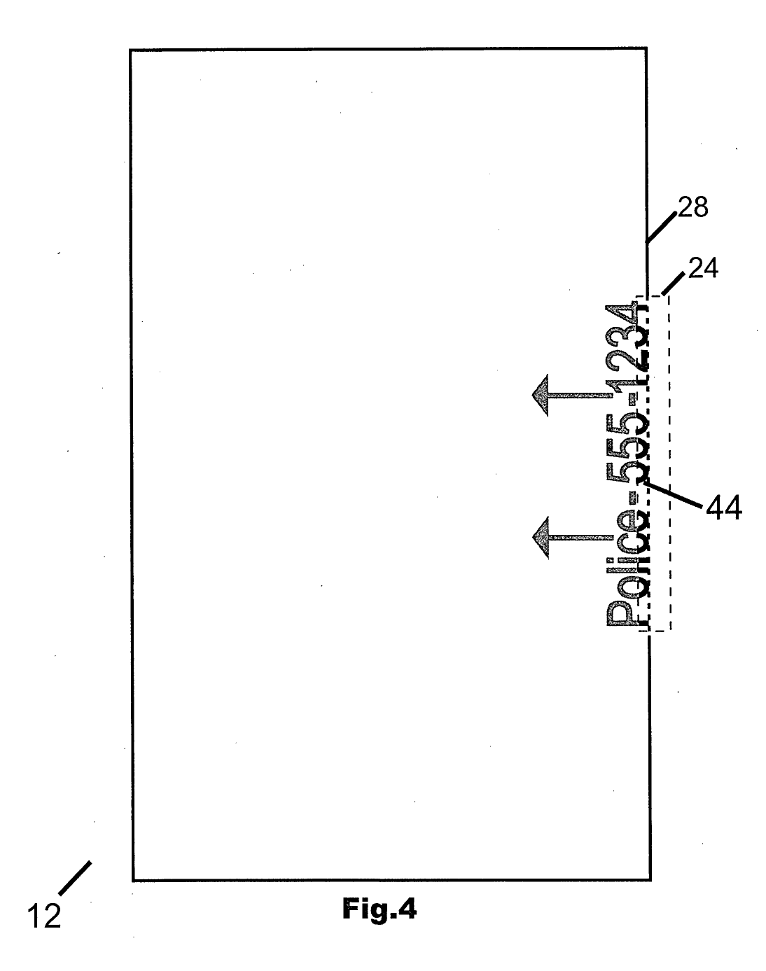

Turning to FIGS. 3-4, it is shown how the open edge image 16 is crept through the window 24. The open edge image “Police 555 1234” begins at a first sheet 60 page border 28 depicted in FIG. 3. The open edge image “Police 555 1234” terminates after it is finally crept through the final sheet page 160 border depicted in FIG. 4. The increments in between are not depicted but it is easily understood that many page sheets occur in between the first and final page sheets 60 and 160 respectively, with incremented portions of “Police 555 1234”.

It should be noted that the entire obverse page area 14, depicted in FIG. 5, will be printed as it is normally printed with the exception of the window 24 of the present invention. The result is that the obverse surface page area 14 will appear mostly the same, but the open edge image 16 now appears to the open edge surface area 20 of the book, depicted in FIG. 6. For bound documents with thinner pages, the open edge image will have a clearer resolution than for bound documents with thicker pages.

Turning to FIG. 5, there is depicted a portion 44 of the open edge image 24 as will be printed for the last page sheet depicted in FIG. 4. Obviously, the amount of the portion 44 shown appears rather large in FIG. 5. However, when the window tolerances are properly registered the desired effect is to make that portion 44 almost unnoticeable.

It must be understood that more than one open edge image may be printed to a single open edge surface. Also, the open edge image or images may be printed to more than one open edge surface. In other words, the open edge image may be printed to a top, bottom or side open edge surface or any combinations thereof.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A method for printing at least one open edge image to a bound document having a plurality of page sheets, wherein each of said page sheets has at least one obverse surface, wherein each of said page sheets includes at least three open edges, wherein said plurality of page sheets forms at least three open edge surfaces, and wherein at least one open edge image is printed to at least one of said open edge surfaces, said method comprising:
the step of entering open edge image data indicative of said at least one open edge image into a memory;
the step of positioning the open edge image data;
the step of setting up at least one open edge window;
the step of creeping said open edge image data;
the step of printing said open edge image data; and
the step of cutting and binding said paper into a bound document.

2. The method of claim 1, wherein the step of printing said open edge image data further includes the step of exporting said positioned and said crept open edge image data to at least one file.

3. The method of claim 1, wherein the step of entering open edge image data further includes the step of scanning a document into a memory.

4. The method of claim 1, wherein the step of entering open edge image data further includes the step of entering data via a keyboard.

5. The method of claim 1, wherein the step of creeping said open edge image data further includes the steps of determining the height of said at least one open edge image, determining the number of pages to which said at least one open edge image shall be printed to, and dividing the height of said at least one open edge image by the determined number of pages to determine a creep increment.

6. The method of claim 1, setting up at least one window further includes the step of overlapping said window to at least one of said at least three open edges.

7. An apparatus for producing an image to an open end of a bound document, wherein said bound document includes a plurality of page sheets, wherein each of said page sheets has at least one obverse surface, wherein each of said page sheets includes at least three open edges, wherein said plurality of page sheets forms at least three open edge surfaces, and wherein at least one open edge image is printed to at least one of said open edge surfaces said apparatus comprising:
open edge image input means for producing open edge image data indicative of at least one open edge image;
storage means for storing said open edge image data;
positioning means for positioning said at least one open edge image;
window set up means for setting up at least one window for said at least one open edge image;
creeping mean for creeping said at least one open edge image through said at least one window; and
printing means for printing said open edge image data onto said at least one obverse surface of said plurality of page sheets; and
binding means for binding said plurality of page sheets.

8. The apparatus of claim 7, further including at least one input scanner for inputting said open edge image data.

9. The apparatus of claim 7, further including a keyboard and monitor for inputting said open edge image data.

10. The apparatus of claim 7, wherein said positioning means further includes height and width adjustment means for determining a height and width of said at least one open edge image.

11. The apparatus of claim 7, wherein said positioning means further includes location determination means for determining the location of said at least one open edge image data relative to said obverse surface of at least one of said plurality of pages.

12. The apparatus of claim 7, further including export means for exporting said positioned and said crept open edge image data to at least one file.

13. The apparatus of claim 10, wherein said creeping means further includes measurement means for determining the number of page sheets that said at least one open edge image shall be printed to and calculating means for dividing said determined height by said determined number of page sheets.

14. The apparatus of claim 7, further including memory within a central processing unit for storing said open edge image data.

15. The apparatus of claim 7, further including memory within a printer housing for storing said open edge image data.

16. A bound document comprising:
a plurality of pages, wherein each of said pages includes at least one obverse surface, said obverse surface including at least three open edges, wherein each of said open edges includes an obverse surface border area, and wherein said plurality of pages forms at least three open edge surfaces;
at least one page image printed to the at least one obverse surface of at least one obverse surface of at least one of said plurality of pages; and
at least open edge image printed to at least one of said open edge obverse surface border areas of said at least one of said pages, wherein said open edge image data produces a visible open edge image to at least one of said three open edge surfaces.

17. The bound document of claim 16, further including at least one window on said at least one obverse surface of at least one of said plurality of pages in which at least a portion of said at least one open edge image is printed therein.
